(19) United States
(12) Patent Application Publication
(10) Pub. No.: US 2024/0346380 A1
(43) Pub. Date: Oct. 17, 2024

(54) EFFICIENT DATA AUGMENTATION FOR MOTION SENSOR AND MICROPHONE RELATED MACHINE LEARNING APPLICATIONS IN EMBEDDED DEVICES

(71) Applicant: InvenSense, Inc., San Jose, CA (US)

(72) Inventors: Juan S. Mejia SANTAMARIA, San Jose, CA (US); Abbas ATAYA, Menlo Park, CA (US); Rémi Louis Clément PONÇOT, Grenoble (FR)

(21) Appl. No.: 18/634,510

(22) Filed: Apr. 12, 2024

Related U.S. Application Data
(60) Provisional application No. 63/495,733, filed on Apr. 12, 2023.

(51) Int. Cl. G06N 20/00

(52) U.S. Cl. CPC G06N 20/00

(57) ABSTRACT

Disclosed embodiments provide data augmentation techniques in which collected sensor data and simulated sensor data created by transforming collected sensor data are used to train a machine learning model (MLM), the MLM is then deployed on an integrated circuit chip of an embedded device, live sensor data received by the embedded device is then either transformed and input to the MLM or input to the MLM without transformation, and the MLM then performs a prediction by, for example, recognizing a gesture made by the user of the embedded device.

### PRIORITY CLAIM

The subject patent application claims priority to the provisional patent application entitled EFFICIENT DATA AUGMENTATION FOR MOTION SENSOR MACHINE LEARNING APPLICATIONS IN EMBEDDED DEVICES, having the application No. 63/495,733, and having the filing date of Apr. 12, 2024.

### TECHNICAL FIELD

The subject disclosure relates to data augmentation and machine learning predictions in mixed analog and digital systems and, more specifically, to making machine learning predictions in consumer electronics devices including microphones and wearable motion sensors.

### BACKGROUND

Data is king in Machine Learning (ML). Good quality data generates good quality machine learning models (MLMs) that output good quality predictions. On the other hand, if poor or bad data is used to create a ML model (MLM), a poor or bad MLM will be created. Moreover, the more the data and more diverse the data that is used, the better the MLM which will be created. The problem in conventional systems is that good data is not always available easily or in abundance. Even in applications for which data is available in abundance, creating properly and precisely labeled data is a cumbersome and time-consuming effort that slows down the progress for any project and makes the work in the project less agile. Properly labelled sensor data is not abundant, especially in the case of building ML solutions to detect very specific gestures from motion or microphone sensor data.

### SUMMARY

The following presents a simplified summary of the specification to provide a basic understanding of some aspects of the specification. This summary is not an extensive overview of the specification. It is intended to neither identify key or critical elements of the specification nor delineate any scope particular to any embodiments of the specification, or any scope of the claims. Its sole purpose is to present some concepts of the specification in a simplified form as a prelude to the more detailed description that is presented later.

In a non-limiting example, exemplary devices, systems, and methods provide an off-chip training component for training a machine learning model (MLM) by using collected sensor data of a first condition. Collected data means that the data is collected from an actual sensor (motion or microphone). The collected sensor data is then used to create simulated sensor data corresponding to one or more other conditions. Simulated data means data that is same or very similar to what collected data would have been for the other conditions, as if such data were actually collected from real-world sensors, except that the simulated data is not actually collected and is in fact simulated by using the collected data for the first condition. Simulation is done by transforming or mapping the collected sensor data into simulated sensor data by using one or more transformation functions. In other words, simulation is a mathematical process and real-world data collection is not involved in simulation. The MLM is then deployed and stored on an integrated circuit chip of an embedded device. There is an on-chip component for receiving real time incoming sensor data (also known as live sensor data) of a second, third or a fourth condition (of many possible conditions). In some embodiments, mapping (or transformation) function(s) are used to map/transform the incoming live sensor data of the second condition (for example) on-chip to the collected sensor data of the first condition. In some embodiments, the mapped/transformed data is then input to the MLM stored on the chip. The MLM is then used to perform predictions or inferences. In the first condition, the sensor is in a first arrangement, and in the second condition, the sensor is in a second arrangement, and so on. The first and second arrangements are different arrangements from each other. In some embodiments, the MLM is trained to recognize the condition of the live sensor data apriori, meaning that the condition is not explicitly identified prior to inputting live sensor data to the MLM.

These and other embodiments are described in more detail below.

### BRIEF DESCRIPTION OF THE DRAWINGS

Various non-limiting embodiments are further described with reference to the accompanying drawings, in which:

FIG. 1 depicts a functional block diagram for the conventional method for creating a machine learning model (MLM);

FIG. 2 depicts a functional block diagram of an exemplary data transformation (or mapping) methodology for incorporation of various non-limiting aspects of the subject disclosure;

FIG. 3 depicts examples of different conditions or device arrangements, demonstrating further non-limiting aspects of the subject disclosure;

FIG. 4 depicts an exemplary block diagram demonstrating further non-limiting aspects of the subject disclosure related to off-line data augmentation;

FIG. 5 depicts an exemplary block diagram demonstrating further non-limiting aspects of the subject disclosure related to on-chip transformation;

FIG. 6 depicts another exemplary block diagram demonstrating other non-limiting aspects of the subject disclosure related to performing data augmentation by using a single MLM;

FIG. 7 depicts another exemplary block diagram demonstrating other non-limiting aspects of the subject disclosure related to performing data augmentation by using separate MLMs;

FIG. 8 depicts another exemplary block diagram demonstrating other non-limiting aspects of the subject disclosure related to data augmentation by using offline data augmentation for one condition and on chip mapping for another condition;

FIG. 9 illustrates equations for data transformation or mapping, according to various non-limiting aspects of the subject disclosure;

FIG. 10 illustrates exemplary equations for using perturbations to enrich a data set and compensating for perturbations and misalignments that can happen during head gestures;

FIG. 11 illustrates an exemplary flow diagram for methodology, according to various non-limiting aspects of the subject disclosure; and

FIG. 12 depicts a functional block-diagram of an exemplary computing device suitable for practicing various non-limiting aspects described herein.

### DETAILED DESCRIPTION

While a brief overview is provided, certain aspects of the subject disclosure are described or depicted herein for the purposes of illustration and not limitation. Thus, variations of the disclosed embodiments as suggested by the disclosed apparatuses, systems, and methodologies are intended to be encompassed within the scope of the subject matter disclosed herein.

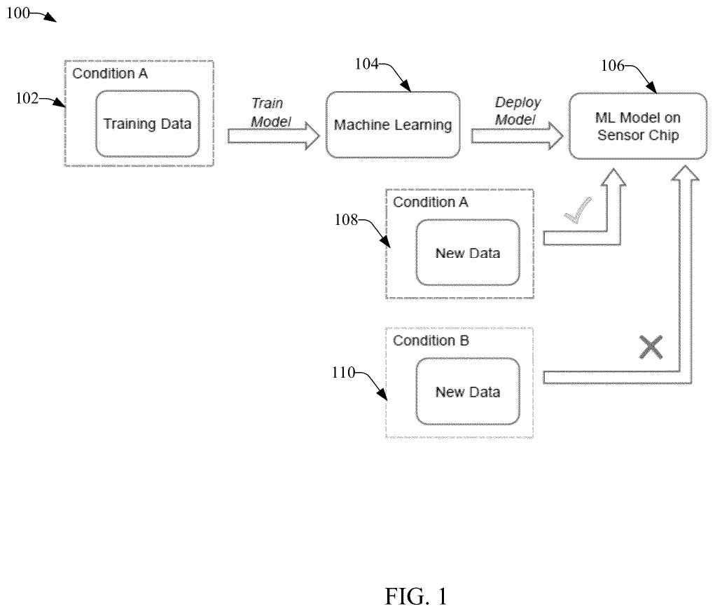

FIG. 1 illustrates a conventional solution for generating a machine learning model (MLM). In block diagram 100, a methodology is shown in which sensor data 102 is collected for a specific condition and a specific ML application (e.g. a head gesture or a hand gesture). What is meant by condition is discussed below in detail. The collected data 102 is for condition A. In the conventional solution, the MLM 104 is trained with the collected data 102. The ML model 104 is deployed on an integrated circuit sensor chip 106. The chip 106 can be in an embedded device, for example, a cell phone. In the conventional solution, because the MLM has learnt from data in one condition setting only (Condition A), it provides good predictions/decisions/inferences for live sensor data received for that same condition settings (108) but fails to recognize live sensor data received for another condition settings (110). In conventional systems, conditions refer to circumstances or settings in which the data was collected, either for training or live sensor data. In embodiments of the inventions disclosed herein, conditions also refer to circumstances or settings for which collected data is simulated. The classic/conventional approach of data collection for multiple conditions, where data is collected for every condition, is a major bottleneck and slowdown in building efficient and generalizable ML solutions.

Some examples of different conditions are as follows. Condition A is a device worn on left ear (or left hand); condition B is a device worn on right ear (or right hand). Condition A is a device worn in a specific orientation; condition B would be a device in a different orientation. Condition A is specific device mounting; condition B is an altered device mounting. Condition A is an activity/gesture done while person is motionless; condition B is same activity/gesture done when person is in motion. Condition A is activity/gesture done while person is standing/sitting; condition B is same activity/gesture done with the person is laying down. Condition A is a microphone in a quiet environment; condition B is a microphone in a noisy environment. Condition A is a microphone situated very close to a person's mouth; condition B is a microphone situated further away from a person's mouth.

To address data gathering bottlenecks, the subject disclosure discloses effective approaches to implement data-augmentation techniques. These techniques create new and useful data from existing data via one or more transformation functions. That both minimizes the burden of data gathering\collection and provides sufficient data to create good performing models. Data augmentation and transformation enables coverage of multiple conditions by using the data that has been collected for just one condition. Traditionally/conventionally, for an ML application that covers multiple conditions, the solution has been to collect data for each condition separately. However, that is limited in its usability and places heavy burdens in terms of cost and time.

The described embodiments herein can be described as a framework to do efficient data augmentation (proper reuse of data) for motion sensors and microphones related machine learning applications in embedded devices. The embedded devices can include both wearable and non-wearable devices such as internet of things (IoT) devices, home appliances, toys, smart speakers, televisions, and phones. In various examples, augment augmentation is done by training the MLM offline, deploying the MLM to an integrated circuit chip of an embedded device, and performing transformation of live sensor data on the chip.

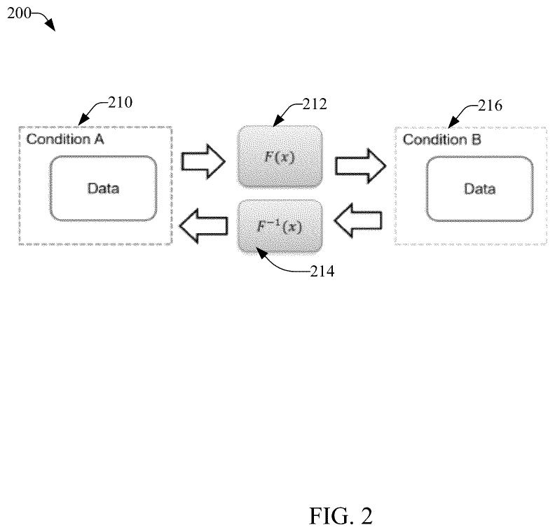

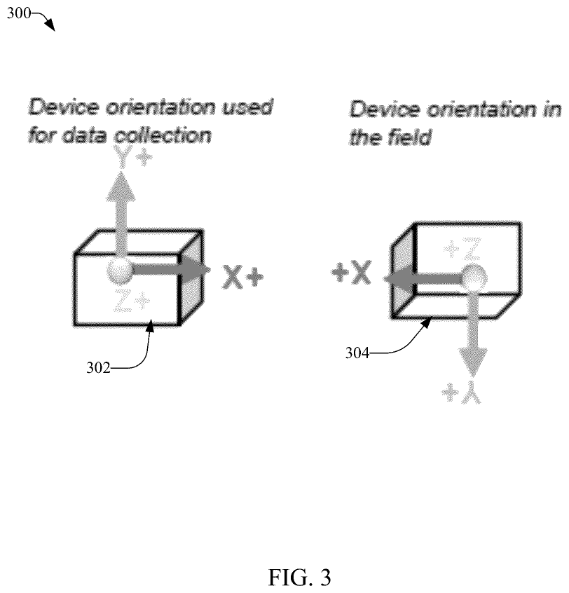

FIG. 2 illustrates an example methodology 200 for data transformation (or mapping). The mapping function F(x) 212 transforms data from condition A 210 to condition B 216. Data collected in condition A 210 can then be mapped to simulate data in condition B 216. Similarly, the inverse mapping F\hat{ }(−1) (x) 214 transforms data collected in condition B 216 to simulate data in condition A 210. Offline training can use both original (or collected) and simulated data, or a subset of the data. An example of such a transformation is a linear transformation that addresses the difference in the sensor mounting. FIG. 3 illustrates conditions or arrangements 300 in which the end device in the field (e.g. an earbud or a wristwatch) that has a motion sensor is mounted (or turned by head/hand movement) in a different orientation 304 from the orientation of the device that was used for data collection 302. Orientation 302 can be called condition A and orientation 304 can be called condition B. Data transformation techniques of the subject disclosure allow for generation and simulation of data for a new device orientation by using the data collected in a different device orientation.

In another example, data is collected using sensor mounted on left hand or left ear of the user (210) for applications concerning hand gestures (boxing, swimming, gym, physical activity) or head gestures (control (e.g. yes or no), swimming, activity, gym). In this example, the mapping (212) is performed to use the collected data (210) to generate simulated data corresponding to device mounted on right hand or right car of the user (216). In another example, the collected data is from one device orientation (e.g. 302) and is used to generate simulated data corresponding to a different device orientation (e.g. 304). In realistic scenarios, an end user might wear/hold the device in various unknown orientations (304) including: (1) headphones or earbuds to detect head gestures, or (2) a phone device for detecting, walking, or running.

Regarding microphones, the purpose of audio augmentation on clean collected data (e.g. microphone near mouth and in a quite environment) is to cover all acoustic environments (noise and reverberation) with multiple transformations. To do so, recorded microphone data (collected data) is simulated for many conditions including many different devices (e.g. wearables, IoT, home appliances, and toys), and many different use cases (e.g. inside, outside, near, far, with noise or without noise . . . ). Each variation or possibility is a different condition. Data for each condition is simulated by using different linear and non-linear maps including, for example, transfer functions, additive sensor noise and background noise, as well as non-linear time-stretching and frequency-stretching techniques. In some embodiments, MLM can make predictions and inferences without requiring on-chip mapping (discussed below in detail). On the other hand, in some embodiments related to microphones, on-chip processing would be required prior to inputting data to the MLM for predictions/inferences purposes. This can happen, for example, when denoising or deverberation of live microphone data is done on-chip to recover the original clean data (e.g. user's spoken words or command), which, in turn, is input to the MLM. In these embodiments, the denoising or deverberation is done both during training of the model (MLM) and during on-chip processing of live sensor data.

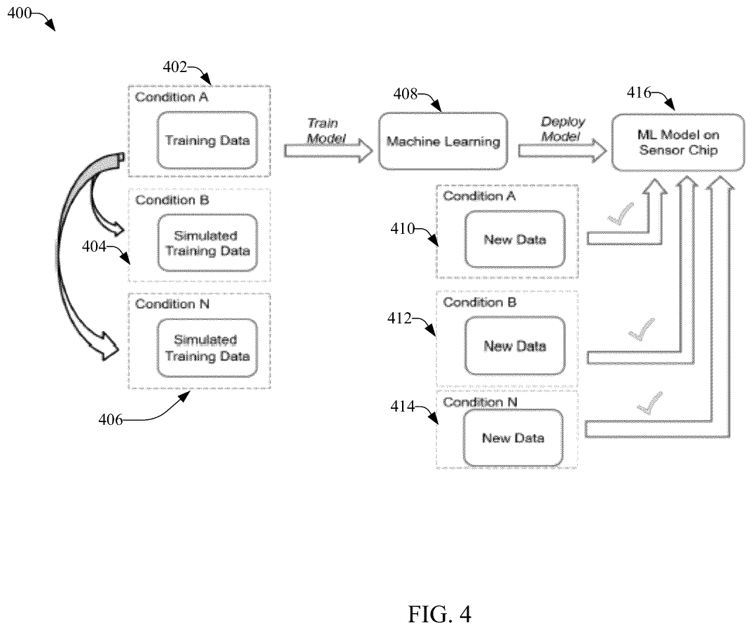

FIG. 4 illustrates an exemplary block diagram 400 for off-line data augmentation techniques. Collected data for condition A 402 is used to generate simulated data for condition B 404 and Condition C 406 by using several transformation functions. Several other conditions are also possible. The data for conditions A, B and C 402, 404 and 406 is referred to as training data because it is used to train the MLM 408. The collected data, which is generated by using actual sensors (motion or microphone), and simulated data from initial (collected) condition are added to the training dataset, such that the generated MLM accounts for those cases. The training happens off-line. The MLM is then deployed to a sensor chip 416. When live data is received by the sensor chip for conditions A, B or C 410, 412 and 414, meaning, data corresponding to initial and multiple new conditions, the deployed MLM 416 can now detect and predict the right decisions corresponding to data in each of the conditions 410, 412 and 414.

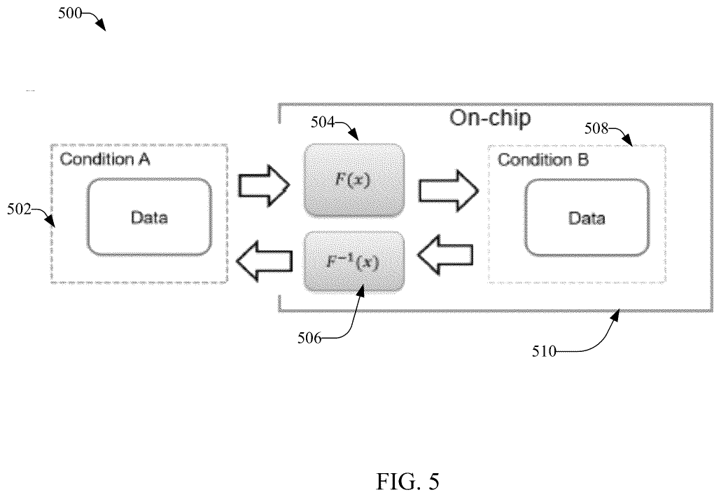

FIG. 5 illustrates a block diagram 500 for alternate methodology for training an MLM. The mapping F(x) (504) transforms data from condition A 502 to condition B 508 on-line (on-chip) 510. Data collected in condition A 502 is mapped to simulate data in condition B 508 prior to being used by the ML model. Similarly, the inverse mapping (or transformation) F\hat{ }(−1) (x) 506 from condition B 508 to condition A 502 can be done on chip 510. Similar mappings can be done to transform data from condition A to any one of the other conditions, and vice versa. Models are trained only based on the data collected in initial condition A 502. An algorithm or logic is implemented in the chip to detect the condition to which the incoming live sensor data corresponds to. Alternatively, the user can input this condition to the device. For example, if the user is wearing the device in right hand instead of left hand, the user can communicate this selection to the device, which will be considered when preprocessing the data for inputting to the ML model. In other cases, this determination of which hand the user is wearing the device can be determined automatically by logic, or algorithm on chip a priori. That means the MLM has been trained to recognize the condition. In sum, the trained model on the chip expects data to be represented in condition A. In the field, the chip processes the data as follows: 1) by determine whether live data is for condition A or B, or some other arrangement (e.g., left or right hand, orientation 1 or orientation 2); 2) by applying the logic/algorithm that maps the data from the detected condition to condition A; and 3) by using the mapped data as input to the ML model. The ML model, though trained with condition A data, can make accurate decisions for any new condition that's accounted for during the pre-processing of the data.

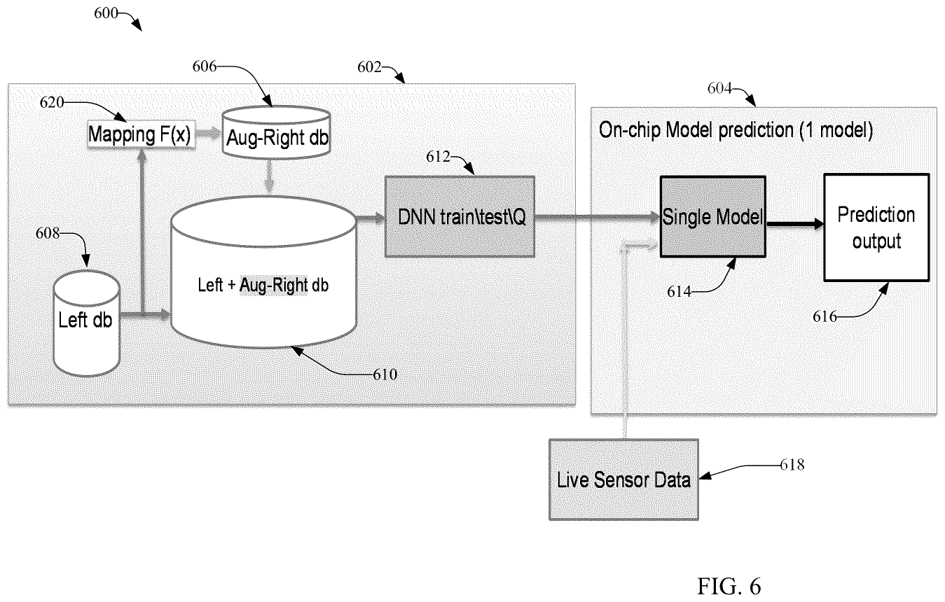

Various proposals for performing efficient data augmentation are now described with references to FIGS. 6, 7, and 8. These figures show frameworks 600, 700, 800 to perform efficient data augmentation to be used in ML motion sensor and microphone applications, both offline and online. By doing data augmentation for each condition that an ML application is designed to cover, the techniques illustrated in these figures reduce the required data collection, which, in turn, has a significant impact on reduction in cost and time for MLM building. For example, paying somebody to collect data, on occasions, can take up to weeks or longer. Also, these techniques speed up the deployment of an ML application by reducing the time of data collection. In some cases, if data already exists, it only needs to be augmented or transformed, such that algorithm prototyping for building a MLM can commence. Also, these techniques improve the performance of certain ML algorithms by generating richer data sets as inputs.

Typically, all MEMS sensors and microphones that have on-chip processing capabilities for supporting ML algorithms (decision trees, DNNs). These capabilities can (1) improve the range\number of conditions a particular ML application can cover and (2) reduce the size of some solutions.

FIG. 6 illustrates a method for offline data augmentation in which a single model (MLM) is used for all data together. The MLM can be used for detecting a user's head or hand gestures, for example. Block 602 depicts off-line components and block 604 depicts sensor chip components. In one embodiment, left data 608 is collected from an actual sensor. The left data 608 is augmented by using the mapping/transformation function 620 to create the simulated right data 606. Both the collected data 608 and the simulated data 606 are input to the off-line database 610. In another embodiment, both the right data and the left data are collected data from actual sensors. The collected right data is augmented to create simulated left data. The collected left data is augmented to create simulated right data. The collected right and left data and the simulated right and left data are all input to the off-line database 610. All four datasets are used to train the MLM. Augmenting left data with right data and right data with left data results in a strong MLM. The MLM is trained and tested at block 612. The training and testing can be performed by using a deep neural network (DNN) and quantization. The MLM is then deployed on chip 604 and used to perform predictions 616 on live sensor data 618. The live data 618 can be input to the MLM 614 without pre-processing or mapping. The MLM 614 is trained to determine the condition (e.g. left hand or right hand) apriori. The method 600 can be further refined by augmenting right data 606 into left data before inputting it to the off-line database 610, which then again maps that left data to right data. Similarly, method 600 can be further refined by augmenting left data 608 into right data before inputting it into off-line database 610, which then again maps that right data to left data. The method 600 can be further refined by taking resulting combined data 610 and applying another mapping (repeatedly) with different values representing small rotation disturbances to account for sensor misalignments around a nominal mount position.

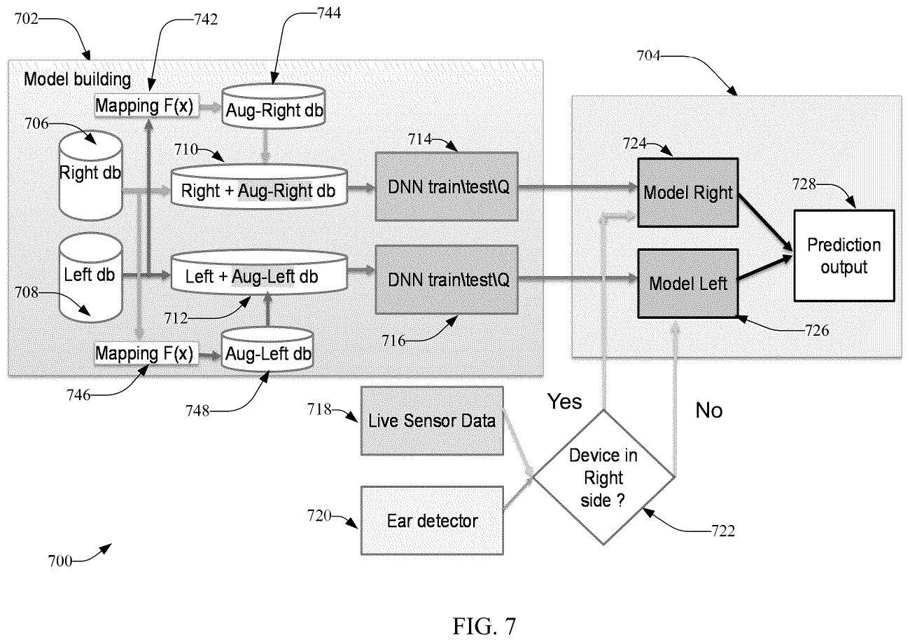

FIG. 7 illustrates a method for offline data augmentation in which separate MLMs are used, for example, for recognizing head gestures made by left and right sides of the head separately. In method 700, data augment happens data off-line in block 702. The right data 706 is collected from an actual sensor. The mapping function 746 augments the right data 706 to create simulated left data 748. The left data 708 is also collected data from an actual sensor. The mapping function 742 augments the left data 708 to create simulated right data 744. The right data 706 and the augmented left data 748 are inputted to the off-line database 712. The left data 708 and the right data 744 are inputted to the off-line database 710. The database 710 uses right data 706 and the simulated right data 744 to build the right MLM 714. The database 712 uses the collected left data 708 and the simulated left data 748 to build the left model 716. The left and right MLMs are then deployed on sensor chip 704. In one embodiment, block 722 detects whether live sensor data 718 is coming from user's left ear or right car by using an car detector 720 or a manual input from the user. In another embodiment, that determination is made a priori by the MLMs 724 and 726. In this embodiment, the determination is not explicitly made. The relevant MLM 724 or 726 is trained to recognize the gesture without explicitly first explicitly determining if it was made by the left ear or the right car. The relevant MLM 724 or 726 then makes the prediction 728 (gesture recognition). The prediction can be based on regression analysis or classification analysis.

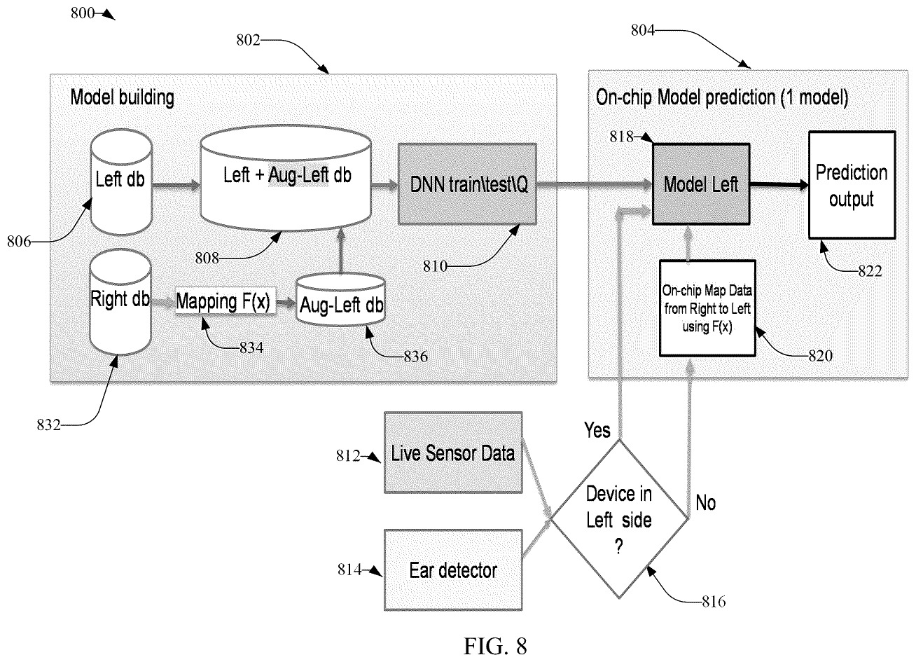

FIG. 8 illustrates a method in which data augmentation happens off-line for one side and mapping happens on chip for the other side. The block diagram 800 illustrates an off-chip component 802 and an on-chip component 804. Left data 806 is collected by using an actual sensor. Right data 832 is collected by using an actual sensor also. The mapping function 834 converts the right data 832 into simulated left data 836. The collected left data 806 and the simulated left data 836 are inputted to the off-line database 808. The database 808 uses the datasets 806 and 836 to build the left MLM 810. The model is then deployed on chip 818. The block can detect whether live sensor data 812 is coming from user's left ear or right ear by using an car detector 814 or a manual input from the user. If from the left ear, the MLM 818 makes the prediction 822. If from the right ear, component 820 first performs right to left mapping before the MLM 818 performs prediction 822. It is to be understood that left and right are used as examples, and the method 800 would be applicable to two different conditions. Also, prediction can also be referred to as inference.

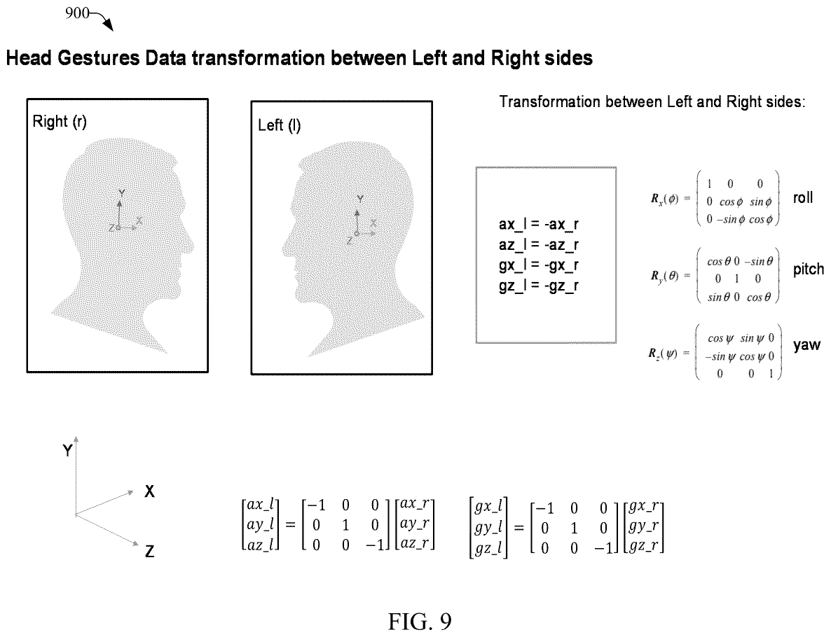

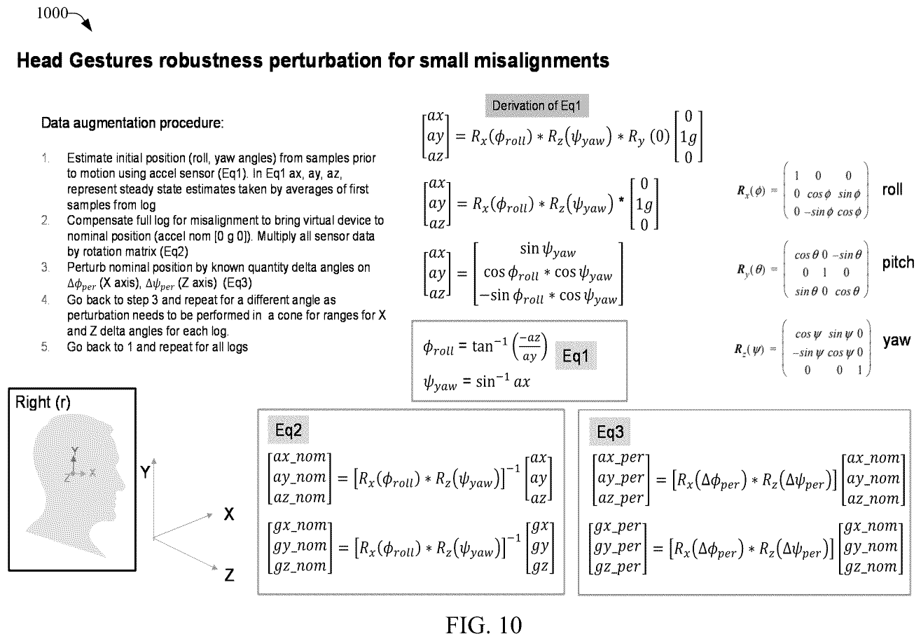

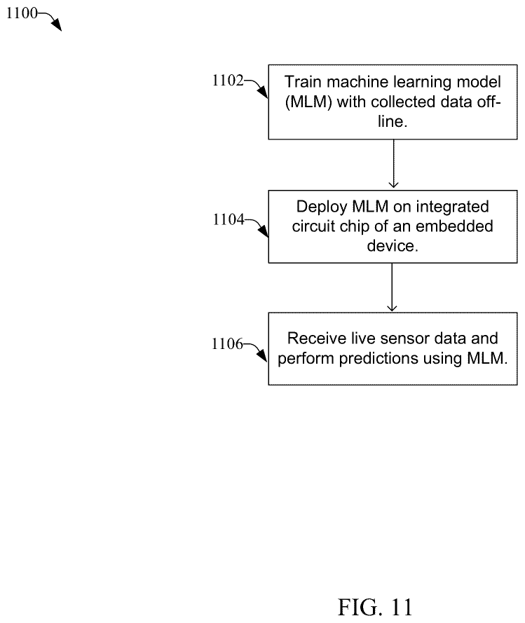

FIG. 9 illustrates exemplary equations 900 for transforming head gesture sensor data collected from a person's right side and creating simulated sensor data corresponding to the person's left side. FIG. 10 illustrates exemplary equations 1000 for compensating for perturbations and misalignments that can happen during head gestures. FIG. 11 illustrates an example flow diagram 1100 for a method according to the subject disclosure. At step 1102, a MLM is trained off chip by using collected sensor data. At step 1104, the MLM is deployed to an integrated circuit chip of an embedded device. At step 1104, the chip receives live sensor data and the MLM uses it to perform a prediction (or inference). The steps 1102, 1104, and 1106 can be implemented according to the variations discloses in FIGS. 6, 7 and 8.

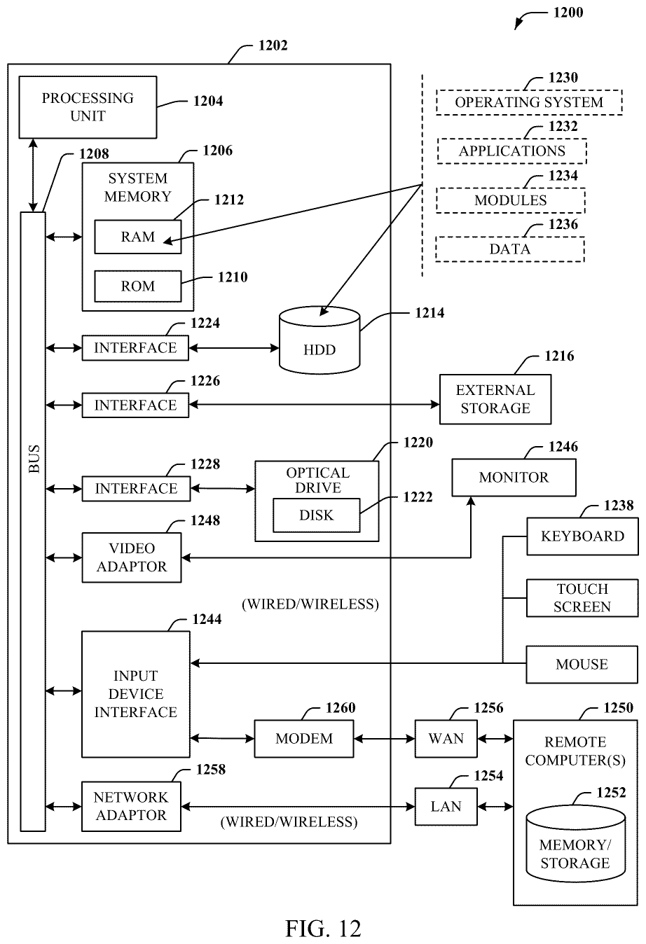

FIG. 12 depicts a functional block-diagram of an exemplary computing device suitable for practicing various non-limiting aspects described herein. Various components of the computing environment can be implemented in the off-line device, the chip, or the end device having the sensor (motion or microphone). In order to provide additional context for various embodiments described herein, FIG. 12 and the following discussion are intended to provide a brief, general description of a suitable computing environment 1200 in which the various embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, and related data, that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

Some aspects of illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, and similar devices) and an optical disk drive 1220 (e.g., which can read or write from a CD-ROM disc, a DVD, a BD, and similar devices). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enable with a security module, such as a trusted processing module (TPM). For instance with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, and similar interfaces.

A monitor 1246 or other type of display device can be also connected to the system bus 1208 via an interface, such as a video adapter 1248. In addition to the monitor 1246, a computer typically includes other peripheral output devices (not shown), such as speakers, printers, and similar devices.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, bin), and telephone. This can include Wireless Fidelity (Wi-Fi) and BLUETOOTH® wireless technologies. Thus, the communication can be a predefined structure as with a conventional network or simply an ad hoc communication between at least two devices.

What has been described above includes examples of the embodiments of the subject disclosure. It is, of course, not possible to describe every conceivable combination of configurations, components, and/or methods for purposes of describing the claimed subject matter, but it is to be appreciated that many further combinations and permutations of the various embodiments are possible. Accordingly, the claimed subject matter is intended to embrace all such alterations, modifications, and variations that fall within the spirit and scope of the appended claims. While specific embodiments and examples are described in subject disclosure for illustrative purposes, various modifications are possible that are considered within the scope of such embodiments and examples, as those skilled in the relevant art can recognize.

As used in this application, the terms “component,” “module,” “device” and “system” are intended to refer to a computer-related entity, either hardware, a combination of hardware and software, software, or software in execution. As one example, a component or module can be, but is not limited to being, a process running on a processor, a processor or portion thereof, a hard disk drive, multiple storage drives (of optical and/or magnetic storage medium), an object, an executable, a thread of execution, a program, and/or a computer. By way of illustration, both an application running on a server and the server can be a component or module. One or more components or modules scan reside within a process and/or thread of execution, and a component or module can be localized on one computer or processor and/or distributed between two or more computers or processors.

As used herein, the term to “infer” or “inference” refer generally to the process of reasoning about or inferring states of the system, and/or environment from a set of observations as captured via events, signals, and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In addition, the words “example” or “exemplary” is used herein to mean serving as an example, instance, or illustration. Any aspect or design described herein as “exemplary” is not necessarily to be construed as preferred or advantageous over other aspects or designs. Rather, use of the word, “exemplary,” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while an aspect may have been disclosed with respect to only one of several embodiments, such feature may be combined with one or more other features of the other embodiments as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A method, comprising:
collecting, by a system comprising at least one processor from a sensor, sensor data associated with a first condition, resulting in collected sensor data;
based on the collected sensor data, using, by the system, a transformation function to create simulated sensor data associated with a second condition that is different from the first condition, wherein the transformation function implements a known relationship between the collected sensor data and the simulated sensor data; and
training a machine learning model using the combination of the collected sensor data and the simulated data,
wherein the first condition being present represents that the sensor is in a first arrangement, and
wherein the second condition being present represents that the sensor is in a second arrangement that is different from the first arrangement.

2. The method of claim 1, wherein the collecting comprises collecting the sensor data from a wearable motion sensor.

3. The method of claim 1, wherein the collecting comprises collecting the sensor data from a microphone.

4. The method of claim 1, wherein, in the first condition, the wearable sensor is situated in the left ear of a user of the wearable sensor, and, in the second condition, the wearable sensor is situated in a right ear of the user of the wearable sensor.

5. The method of claim 1, wherein, in the first condition, the wearable sensor is situated on the left hand of a user of the wearable sensor, and, in the second condition, the wearable sensor is situated on the right hand of the user of the wearable sensor.

6. The method of claim 1, wherein the sensor data associated with the first condition refers to the sensor data generated by a head gesture of a user of the wearable sensor.

7. The method of claim 1, wherein the sensor data associated with the first condition refers to the sensor data generated by a hand gesture of a user of the wearable sensor.

8. The method of claim 1, further comprising: another system embedded in a consumer electronics device for receiving real time incoming sensor data, wherein the another system is different from the system for using the transformation function to create simulated data, wherein using the another system to make a prediction based on the real time incoming sensor data using the machine learning model.

9. The method of claim 1, further comprising: based on the collected sensor data, using, by the system, a plurality of transformation functions to create simulated sensor data associated with a plurality of conditions that are different from the first condition, wherein the transformation functions implement known relationships between the collected sensor data and the simulated sensor data.

10. The method of claim 1, further comprising: collecting, by the system comprising at least one processor from a sensor, sensor data associated with the second condition, resulting in collected sensor data;
based on the collected sensor data, using, by the system, a transformation function to create simulated sensor data associated with first condition that is different from the first condition, wherein the transformation function implements a known relationship between the collected sensor data and the simulated sensor data; and
training a machine learning model using the combination of the collected sensor data for the first and second conditions and the simulated data for the first and the second conditions.

11. A non-transitory machine-readable medium, comprising executable instructions that, when executed by at least one processor, facilitate performance of operations, comprising:
in response to receiving real time incoming sensor data associated with a second condition,
using a mapping function to map the sensor data associated with the second condition to data associated with a first condition, wherein the mapping function is usable by an integrated circuit chip of a consumer electronics device;
using the mapped data as an input to a machine learning model stored in memory of the integrated circuit chip; and
making a prediction by using the machine learning model;
wherein the first condition represents that the sensor is in a first arrangement, and
wherein the second condition represents that the sensor is in a second arrangement that is different from the first arrangement.

12. The non-transitory machine-readable medium of claim 11, wherein making the prediction comprises performing one of a classification analysis or a regression analysis.

13. The non-transitory machine-readable medium of claim 11, wherein receiving the real time incoming sensor data comprises receiving the sensor data from a wearable motion sensor or a wearable microphone.

14. The non-transitory machine-readable medium of claim 11, wherein the operations further comprise: determining that the real time incoming sensor data is associated with the second condition.

15. The non-transitory machine-readable medium of claim 11, wherein the integrated circuit chip is part of a first computing system, and wherein the operations further comprise:
receiving the machine learning model and the mapping function from a second computing system that trained the machine learning model based on the first sensor data associated with the first condition.

16. A system, comprising:
a first component comprising a first integrated circuit chip, wherein the first component is configured to train a machine learning model by using collected sensor data in a first condition and simulated sensor data created by transforming the collected sensor data by using a plurality of transfer functions; and
a second component discrete from the first component comprising a second integrated chip configured to receive real time incoming sensor data in a second condition, use a mapping function to map the real time incoming sensor data in the second condition to the collected sensor data in the first condition, use the mapped data as an input to the machine learning model, and use the machine learning model to perform a prediction;
wherein the first condition being present represents that the sensor is in a first arrangement, and
wherein the second condition being present represents that the sensor is in a second arrangement that is different from the first arrangement.

17. The system of claim 16, wherein the second component comprises one of a mobile phone, an earbud, or a wristwatch.

18. The system of claim 16, wherein performing a prediction comprises performing one of a classification analysis or a regression analysis.

19. The system of claim 16, wherein receiving real time incoming sensor data comprises receiving data from a wearable motion sensor.

20. The system of claim 16, wherein receiving real time incoming sensor data comprises receiving data from a microphone.
